(19) United States
(12) Patent Application Publication
(10) Pub. No.: US 2004/0224203 A1
(43) Pub. Date: Nov. 11, 2004

(54) Intermediate temperature proton exchange membranes

(76) Inventors: Murty V. Bhamidipati, Randolph, MA (US); Melissa J. Perkins, Kingston, MA (US); Myles Walsh III, East Falmouth, MA (US)

Correspondence Address: Myles Walsh, III, Cape Cod Research, Inc., 19 Research Road, East Falmouth, MA, 02536, US

(21) Appl. No.: 10/434,530

(22) Filed: May 9, 2003

(51) Int. Cl. H01M 8/10

(52) U.S. Cl. 429/30; 429/33; 429/303

(57) ABSTRACT

The subject invention relates to proton exchange membranes comprising a carbon cluster derivative that comprises a plurality of functional groups so as to be capable of transferring a plurality of protons between each of the functional groups of the carbon cluster derivative, wherein the proton conductor further comprises a dry gel material in addition to the carbon cluster derivative. The proton conductor is usable, even in a dry state, in a wide temperature range including ordinary temperature to an intermediate temperature of about 250° C. An electrochemical device, such as a fuel cell, that employs the proton conductor is not limited by atmospheric conditions and can be of a small and simple construction. The proton conductor may be formed into useful thin films by casting suspensions containing both the carbon cluster derivatives and the chemical precursors of the dry gel material. On exposure to water, sol gel reactions form a wet gel material. This material on aging and exposure to heat cures into films of the invention.

### STATEMENT REGARDING FEDERALLY SPONSORED RESEARCH

This invention resulted from research conducted under Contract No. DAAD 19-03-C-0011 awarded by the U.S. Army Robert Morris Acquisition. The Government has certain rights to this invention.

### BACKGROUND OF THE INVENTION

(1) Field of the Invention

The invention relates to a proton exchange membrane (PEM), a production method thereof, and an electrochemical device using a proton exchange membrane. More specifically, the invention relates to the use of a solid dry gel electrolyte membrane capable of conducting protons under dry conditions at temperatures of up to at least 200° C. in fuel cells.

(2) Description of Related Art

Fuel cells, which convert chemical energy to electric energy cleanly and efficiently, have attracted much attention for possible use in electric power generation. However, despite decades of research, heretofore no electrolyte existed which combined the ability to operate from below room temperature to at least 200° C. under conditions of low humidity for thousands of hours in air and in fuels. The upper limit of known proton exchange membrane (PEM) fuel cell operation is imposed by the properties of the electrolyte. In known PEMs proton conductivity and fuel cell performance degrades at temperatures above about 100° C. This is because most known proton conductors achieve ionic conductivity by entrapping moisture in their structure. Operation above 100° C. requires pressurized systems for terrestrial operation to prevent this water from boiling off.

The operation of fuel cells at ambient pressures in the medium temperature range (from about 150° C. to at least 200° C.) is not possible with known PEMs. This is a very serious problem. Low temperature fuel cell temperature leads directly to low efficiency of energy conversion as well as poisoning of the anode catalysts from the carbon monoxide in the fuel gases.

More recently, a proton conductor also been developed having a conduction mechanism quite different than the above-described proton conductors based on protonated water. It has been found that a composite metal oxide having a perovskite structure, such as, SRCeO₃ doped with Yb, exhibits proton conductivity without the use of moisture as a migration medium. The conduction mechanism of this composite oxide has been considered such that protons are conducted while being singly channeled between oxygen ions forming a skeleton of the perovskite structure.

The conductive protons, however, are not originally present in the composite metal oxide but are produced by reaction with steam contained in an environmental atmospheric gas. The composite metal oxide perovskite structure has a problem that the operational temperature of each conductor becomes high, and more specifically, moisture or steam must be supplied to the conductor to ensure the performance of the conductor.

The composite metal oxide having the perovskite structure has a problem that the operational temperature must be kept at a high temperature of above 500° C. for ensuring effective proton conductivity.

Prior art has attempted to provide proton conductors comprising a functionalized carbon cluster derivative and a polymer material. U.S. Pat. No. 6,495,290 (Dec. 17, 2002), which is included by way of reference, illustrates that this approach yields proton conductors with proton conductivity so low (below 10⁻⁴ S/cm) as to require extremely thin PEM films (300 microns or less). Addition of inert polymer material to achieve the film and mechanical properties needed for practical fuel cells only further reduces this already low value to values as low as 2×10⁻⁷ S/cm.

### SUMMARY OF THE INVENTION

A first object of the present invention is to provide a proton conductor which is usable in a wide temperature range including ordinary temperature and has low atmospheric dependence, that is, it requires no moisture despite whether or not the moisture is a migration medium: to provide a method of producing the proton conductor; and to provide an electrochemical device that employs the proton conductor. To meet this objective, the proton conductor includes a proton conductor material that at least has a number of functional groups so as to be capable of transferring protons between the functional groups of the proton conductor material. The proton conductor includes a wide variety of carbonaceous materials, examples of which are described in greater detail below with respect to various illustrative embodiments of the present invention, such as, the proton conductor, production methods and electrochemical devices thereof.

A second object of the present invention is to provide a proton conductor which exhibits a film formation ability while keeping the above-described performance, to be thereby usable as a thin film having high strength, gas permeation preventative or impermeable performance, and a good proton conductivity, to provide a method for producing the proton conductor, and to provide an electrochemical device using the proton conductor.

After intensive investigations made under circumstances, the inventors have found that films comprising the combination of dry proton conducting phosphate gels and proton conducting carbon cluster derivatives meets all of the main requirements for an ionic membrane useful in under dry conditions in fuel cells. The present invention has been completed on the basis of this finding.

It is yet another object of the present invention to develop a novel PEM suitable for use in fuel cells at temperatures in excess of 200° C.

It is yet another object of the invention to successfully demonstrate the feasibility of combining carbon cluster derivatives with a thermally and chemically stable, high conductivity phosphate gels to yield a PEM with ionic conductivity and high temperature performance superior to that of perfluorosulfonic acid membranes such as Nafion®.

Demonstration of this concept was the first step in achieving the overall technical objective of the instant invention.

These and other objects and features of the instant invention will be apparent from a reading of the following detailed description of the invention.

### DETAILED DESCRIPTION OF THE PREFERRED EMBODIMENTS

Specifically, the invention relates to the use of dry gels containing acid groups. According to the invention, acid gel precursors are combined with a derivatized carbon cluster compound to form via the sol-gel method the films of the invention.

The carbon cluster of the invention generally means an aggregate in which atoms on the order of several hundred are bonded or aggregated to each other. The aggregate improves proton conductivity and ensures sufficient film strength while maintaining its chemical property to be thereby easily formed into a layer. The “cluster mainly or substantially containing carbon atoms” means an aggregate in which a number of carbon atoms, preferably on the order of several hundred, are closely bonded to each other irrespective of the typically known molecular bonding that occurs between carbon atoms.

Although this type of cluster contains a large number of carbon atoms, it is not limited only to carbon atoms and may include a variety of other atoms within its aggregate structure. Hereinafter, a cluster aggregate that contains a large number of carbon atoms—yet may contain other atoms—is referred to as a “carbon cluster”.

Carbon clusters are according to the invention preferably chosen from the group comprising fullerenes, carbon nanotubes, soots and their mixtures. They are commercially available from Carbon Nanotechnologies Inc., Houston, Tex. 77084-5195 and can be synthesized by pyrolizing known organic precursors at temperatures above 900° C. in an inert atmosphere. Tubular carbonaceous material (carbon nanotubes) is characterized in that a ratio of an axial length to a diameter of the tubular carbonaceous material is very large, and further the tubular carbonaceous molecules of this material are entangled in a complicated form or structure that is inherent to this material. They often have strand-like fibers which are “ropes” of parallel, individual single-walled carbon nanotubes. Typical rope diameter is about 20 nm. Typical tube diameter is about 1.4 nm.

Especially preferred carbon clusters are CNₓ nanotubes where x is about 2 to about 7 atomic %. Said nanotubes may be synthesized by pyrolyzing ferrocene/melamine mixtures at 1050° C. in an argon atmosphere. They often form carpet-like structures containing highly oriented nanotubes of uniform diameter (about 10 to 40 nm outer diameter) and length (about 50,000 to 60,000 nm). For nitrogen levels of above about 5 a%, the coordination within the carbon lattice is of the pyridine-type (two bonded C to each N atom), which is different from the direct substitution of 3-fold coordinated carbon, and results in nitrogen sites uniformly distributed over the outer surface of the nanotube. These sites, unlike pure carbon nanotubes which react only at the ends, permit uniform functionlization of the entire tube surface with acid groups.

Known methods described in U.S. Pat. No. 6,495,290 (Dec. 17, 2002) are used to functionalize the carbon clusters. Functionalization changes the carbon clusters from black electron-conducting powders to colored water-soluble or water dispersable proton conductors with very low electronic conductivity. By way of example but not by way of limitation, AC impedance of electronically insulative polyhydroxyfullerene C₆₀(OH)₁₂ has (K. Hinokuma and M. Ata, Chemical Physics Letters, Volume 341, Issues 5-6, 29 Jun. 2001, Pages 442-446) conductivity of 7×10⁻⁶ S/cm at room temperature, which is attributable to proton conductivity.

As a result of the present invention, surprising improvements in proton conductivity under dry conditions can advantageously be achieved by utilizing acidic functional groups expressed by a chemical formula of —XH where X represents an arbitrary atom or atomic group that has a bivalent bound and where H represents a hydrogen atom, and further the group can be expressed by a chemical formula of —OH or —YOH where Y represents an arbitrary atom or atomic group that has a bivalent bound, where O represents oxygen atom, and where H represents a hydrogen atom. Preferred functional groups are chosen for their thermal stability above about 100° C. from the group consisting of hydroxyl, carboxyl, carbonyl, —SO₃H, —OSO₃H, —OP(OH)₃ and their mixtures. Said functional groups are hydrophilic and the functionalized carbon clusters of the invention are dispersed easily in water or alcohols.

According to this embodiment, electron attractive groups, such as, nitro groups, nitrile groups, alkyl halide groups, fluorine atoms or chlorine atoms may be preferably introduced together with the functional groups, to carbon atoms of the fullerene molecule or molecules. The presence of the electron attractive groups in addition to the functional groups increases the ease wherewith protons are released from the functional groups and are transferred between functional groups by the electron attractive effect of the electron attractive groups.

Advantageously, the subject PEM exhibits stable chemical and electrical properties at temperatures well above 100° C. and up to at least 200° C., has good mechanical and film properties, demonstrates high proton conductivity in both dry and wet conditions, and has very low fuel permeability.

The dry gel of the invention generally means an aggregate containing atoms chosen from the dry gel material is an aggregate containing atoms chosen from the group comprising hydrogen, oxygen, phosphorous, silicon, germanium, aluminum, cerium, zirconium and their mixtures. On the order of several hundred of said atoms are bonded or aggregated to each other. The aggregate improves proton conductivity and ensures sufficient film strength while maintaining its chemical property to be thereby easily formed into a layer. “Dry” means that water is largely absent from the structure.

The kind of dry gel is not particularly limited insofar as it does not obstruct the proton conductivity as much as possible (due to the reaction with the functionalized carbon clusters or the like) and has a film formation ability, but may be generally selected from dry gels having no electronic conductivity and exhibiting good stability. Examples of these dry gels may include gels formed by phosphate groups linked by thermally stable networks selected from the group comprising silica, zirconia, alumina and their mixtures. The recited thermally stable networks may be formed via polycondensation reactions (sol-gel processing), may be used in all possible positions, and phosphate gels may be formed from all possible groups, as would be known to the skilled artisan.

Gels of very uniform chemical composition are preferred for their improved material properties and for their improved proton conductivity. While mechanical mixing of various starting materials provides useful gels, according to the present invention preferred gels are formed from the hydrolysis of polymers whose main chains comprise repeating links containing atoms selected from the group comprising the dry gel material is an aggregate containing atoms chosen from the group comprising oxygen, hydrogen, phosphorous, silicon, germanium, aluminum, cerium, zirconium and their mixtures.

Especially preferred as a starting material is poly (diethoxysilyl phosphonate). Under the wet conditions used to form the invention, said polymer hydrolyzes into gels by simultaneous attacks at the —Si—O—P— bond and the ethoxy-Si bond. This advantageously synthesizes the gels of the invention through the sol-gel process with the release of ethanol. Extremely uniform gel materials with Si:P atomic ratios of about 1:1 result.

These materials can be formed by known methods according to the invention into the proton conductor comprising a thin film that has a dry film thickness of 300 microns or less. By way of example but not by way of limitation, useful films can be formed by screen printing, by film casting and more preferably by dispersing the carbon cluster derivative in a liquid along with dry gel precursors and filtering the dispersion. A solvent such as THF or ethanol is generally used as a liquid. However, the liquid is not particularly limited insofar as the derivative can be dispersed in the liquid.

By filtering the dispersion, the carbon cluster derivative is deposited in a film shape on the filter. The film contains a mixture of derivative and gel precursor. Evaporation of the solvent as well as product(s) of the sol-gel reactions yields a solid film of wet gel. The film may be boiled in water (100° C.) for 12 h to remove impurities and alcohol solution from the matrix. On drying by heating in ambient air, said wet film is dehydrated to yield the invention whose ionic conductivity at room temperature is essentially the same as that at 200° C.

According to the present invention, tubular carbonaceous material derivatives may be desirably formed as a film to be used for an electrochemical device such as a fuel cell. These materials can be formed by dispersing the tubular carbonaceous material derivative in a liquid containing dry gel precursors and filtering the dispersion. A solvent such as ethanol is generally used as the liquid. However, the liquid is not particularly limited insofar as the derivative can be dispersed in the liquid and the precursors are freely soluble in a wide range of solvents.

By filtering the dispersion, the tubular carbonaceous material derivative is deposited in a film shape on the filter. Such a film has a high strength and can be peeled from the filter. In this case, the film is composed of the combination of wet gel and tubular carbonaceous material. On drying by heating in air the wet film is dehydrated to yield films whose ionic conductivity at room temperature is essentially the same as that at 200° C.

As previously discussed, the proton conductor that mainly includes tubular carbonaceous material derivative is preferably used for a fuel cell. The fuel cell application of this material is similar to the application of the other previously discussed materials. Both of the electrodes of the fuel cell may of the gas type, or if desired, one of the electrodes may be of the active type. The positive active material is typically configured as a material containing nickel hydroxide. The negative active material may be configured as a hydrogen absorption alloy or a hydrogen absorption alloy supported by carbon material.

In the operation in a fuel cell operating on air and utilizing a fuel chosen from the group compromising hydrogen, methanol, ethanol, gasoline, diesel fuel, carbon monoxide, ammonia and their mixtures, the subject PEM conducts protons from the fuel electrode to the oxygen electrode. At temperatures below about 150° C., carbon monoxide, present in fuels like reformed hydrogen, poisons the platinum catalyst commonly used in fuel cells. Liquid fuels like methanol produce even more severe poisoning effects because carbon monoxide is an intermediate in the fuel oxidation process. However, at higher temperatures, approaching 200° C. and above, the cell operation stimulates carbon monoxide oxidation to carbon dioxide, resulting in substantially enhanced catalyst activity in spite of the poisoning effect of carbon monoxide.

PEM Membrane Preparation

The synthesis of poly (diethoxysilyl phosphonate) (1) was synthesized following a literature procedure described in “Diorganosilyl-bis(O-alkylphosphonates” in N. Auner and J. Weiss (ed), “Organosilicon Chemistry: From Molecules to Materials,” VCH, Weinheim, Germany, 1994.

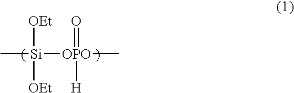

5 g of diethoxy dichlorosilane (Gelest Company, CAS 4667-38-3) was mixed with 2.9 g of dimethyl phosphite (Aldrich Chemical Company, CAS 868-85-9) and stirred for 24 hours while being kept under a nitrogen atmosphere at room temperature. The reaction resulted in a solid white product.

The synthesis of polysulfonated fullerene was performed according to a literature procedure, L. Y. Chaing, L. Y. Wang, J. W. Swirczewski, S. Soled and S. Cameron, J. Org. Chem. 59, 3960-3968 (1994). First, 15 mL of fuming sulfuric acid (Aldrich Chemical Co, CAS 8014-95-7) was slowly added to 1 g of C₆₀ powder (Aldrich Chemical Co, CAS 99685-96-8, 98%) and stirred for 2 days while being kept under a nitrogen atmosphere at 55-60° C. The resultant dark orange solution was quenched with 20 mL of deionized water prior to the addition of 100 mL of methanol with vigorous stirring while in an ice bath. The precipitated product was filtered and dried at ambient temperature.

In a typical example of PEM membrane preparation according to the invention, the 0.05 g of the powder of the poly sulfonated fullerene was mixed with 1 g of tetrahydrofuran (THF), and the mixture was ultrasonically vibrated for 10 minutes, resulting in the complete dissolution of the sulfonated fullerene in the THF solution. Various amounts of poly(silyl phosphonate) (1) were dissolved in 2 g of ethanol and this solution was combined with the poly sulfonated fullerene solution. Said solutions were uniformly mixed by ultrasonic stirring and were then cast into thin films at room temperature. Aging the films in ambient air for 24 hours resulted in gelation of the films.

Conductivity Measurements

The ionic conductivities of the invention were measured using a gold film four probe test apparatus. A uniform thin layer of gel precursor was spin coated onto the surface of an alumina wafer that had four parallel gold lines attached to gold contact pads. Electric current was passed between the outer pair of gold lines. Voltage was measured between the inner pair of gold lines. Contact pads were masked off prior to spin coating to insure good electrical contacts between the pads and the measuring leads. Film samples were evacuated at 60° C. for 24 h in order to remove water, solvent and ethanol left from the sol gel reactions. Dry film thickness was measured with a micrometer. The ac conductivities are measured using a Hewlett Packard 4276A LCZ meter (100 Hz-20 kHz) in a glass chamber as a function of temperature and in dry ambient air.

Test results are given below as a function of temperature and proton conductivity.

TABLE 1. Ionic conductivity (microS/cm) of intermediate temperature PEMs comprising dry phosphosilicate gels and polysulfonated fullerene in inventive examples A, B, C, D and E

| | Wt % Sulfonated | Temperature, ° C. | | | | |
|---|---|---|---|---|---|---|
| SAMPLE | Fullerene | 25 | 100 | 150 | 200 | 220 |
| A | 33.33 | 661 | 37.5 | 25.3 | 29.0 | 362 |
| B | 50 | 9.68 | 8.39 | 8.43 | 34.0 | 169 |
| C | 40 | 5390 | 30.8 | 16.8 | 15.7 | 24.4 |
| D | 60 | 9730 | 393 | 52.9 | 32.8 | 38.9 |
| E | 80 | 7500 | 176 | 21.0 | 19.2 | 32.7 |

The proton conductor mainly containing the fullerene derivative according to the present invention, therefore, can exhibit good proton conductivity in a wide temperature range from room temperature to 220° C. The PEMs comprising less than about 20 wt % dry gel material form films which crack on drying.

TABLE 2. Ionic conductivity (microS/cm) of intermediate temperature PEMs comprising dry phosphosilicate gels containing 33.33 wt % polysulfonated fullerene and in addition 5 wt % of zirconium, aluminum, germanium or cerium precursors.

| | | Temperature, ° C. | | | | |
|---|---|---|---|---|---|---|
| SAMPLE | Precursor | 25 | 100 | 150 | 200 | 220 |
| A | None | 661 | 37.5 | 25.3 | 29.0 | 362 |
| F | Zirconium | 36.2 | 14.8 | 24.2 | 40.0 | 42.0 |
| G | Aluminum | 729 | 35.4 | 27.9 | 376 | 184 |
| H | Germanium | 89.4 | 47.1 | 46.8 | 676 | 532 |
| I | Cerium | 6750.0 | 22.3 | 17.8 | 22.5 | |

According to the invention, 0.05 g of the powder of the polysulfonated fullerene was mixed with 1 g of tetrahydrofuran (THF), and the mixture was ultrasonically vibrated for 10 minutes, resulting in the complete dissolution of the sulfonated fullerene in the THF solution. 0.10 g of poly(silyl phosphonate) (1) was dissolved in 2 g of ethanol and this solution was combined with the poly sulfonated fullerene solution. Said solutions were uniformly mixed by ultrasonic stirring. To this stirred mixture was added 0.0075 g of one of four precursors. Said precursors were obtained from Gelest, Inc.(Tullytown, Pa.) and were respectively zirconium n-propoxide 70% in propanol (23519-77-9), aluminum isopropoxide (555-31-7), tetramethoxygermane (992-91-6) and cerium IV isopropoxide (63007-83-0). The four solutions were cast into thin films at room temperature to form Samples F, G, H, and I. Aging the films in ambient air for 24 hours resulted in gelation of the films. The proton conductors of the invention. resulted from heating said gels above 100° C. to cause both drying of the samples and evaporation of solvents and the volatile products of the sol gel reactions.

The proton conductor gels formed by phosphate groups linked by thermally stable networks selected from the group comprising the dry gel material is an aggregate containing atoms chosen from the group comprising hydrogen, oxygen, phosphorous, silicon, germanium, aluminum, cerium, zirconium and their mixtures, therefore, can exhibits good proton conductivity in a wide temperature range from room temperature to 220° C.

Generating Electricity Using the Film

0.05 g of the powder of the poly sulfonated fullerene was mixed with 1 g of tetrahydrofuran (THF), and the mixture was ultrasonically vibrated for 10 minutes, resulting in the complete dissolution of the sulfonated fullerene in the THF solution. 0.10 g of poly(silylphosphonate) was dissolved in 2 g of ethanol and was combined with the poly sulfonated solution. The combined solutions were ultrasonically vibrated for 2 hours resulting in a homogeneous solution. A fuel cell carbon electrode (EC-20-10-7 from ElectroChem, Inc., Woburn, Mass.) was coated with a film of the invention by the steps of: masking the surface of the electrode by a plastic mask having a rectangular opening, dripping the above-described solution in the opening, spreading the solution in the opening, drying at room temperature in order to vaporize the THF, and removing the mask. The same amount of electrode described above, with its downward surface having a catalyst was laid on the film. The upper electrode was pressed by about 5 tons/cm² to complete a composite. The composite was incorporated in a fuel cell. A generating electricity experiment was performed by supplying hydrogen gas and air to another electrode in the fuel cell. The open circuit was about 1.2 V and the characteristic of the closed circuit voltage was also excellent against the current value of the fuel cell.

The embodiments which have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

Having thus described our invention, what we claim as new and desire to secure by United States Letters Patent is:

1. A proton conductor comprising a carbon cluster derivative that comprises a plurality of functional groups so as to be capable of transferring a plurality of protons between each of the functional groups of the carbon cluster derivative, wherein the proton conductor further comprises a dry gel material in addition to the carbon cluster derivative.

2. A proton conductor according to claim 1, wherein the carbon cluster derivative comprises a substantially carbon structure chosen from the group comprising fullerenes, carbon nanotubes, soots and their mixtures.

3. A proton conductor according to claim 1, wherein said carbon cluster derivative substantially comprises a plurality of carbon clusters.

4. A proton conductor according to claim 1, wherein said carbon cluster derivative substantially comprises CNₓ nanotubes where x is about 2 to about 7 atomic %.

5. A proton conductor according to claim 1, wherein the functional groups are expressed by —XH where X represents an arbitrary atom or atomic group that has a bivalent bound and where H represents a hydrogen atom.

6. A proton conductor according to claim 1, wherein the functional groups are expressed by —OH or —YOH where Y represents an arbitrary atom or atomic group that has a bivalent bound, where O represents oxygen atom, and where H represents a hydrogen atom.

7. A proton conductor according to claim 5, wherein the functional groups selected from the group consisting of hydroxyl, carboxyl, carbonyl, —SO₃H, —OSO₃H, —OP(OH)₃ and their mixtures.

8. A proton conductor according to claim 1, wherein the carbon cluster derivative further comprises a plurality of electron attractive groups in additional to the functional groups.

9. A proton conductor according to claim 8, wherein the electron attractive groups are selected from the group consisting of nitro groups, nitrile groups, alkyl halide groups, fluorine atoms or chlorine atoms.

10. A proton conductor according to claim 1, wherein the dry gel material has no electronic conductivity.

11. A proton conductor according to claim 1, wherein the dry gel material comprises about 20 wt % or more.

12. A proton conductor according to claim 1, wherein the dry gel material is an aggregate containing atoms chosen from the group comprising hydrogen, oxygen, phosphorous, silicon, germanium, aluminum, cerium, zirconium and their mixtures.

13. A proton conductor according to claim 12, wherein the atomic ratio of phosphorus to silicon is about 1.

14. A proton conductor according to claim 1, wherein the proton conductor comprises a thin film that has a dry film thickness of 300 microns or less.

15. An electrochemical device comprising a first electrode, a second electrode, and a proton conductor that is positioned between the first and second electrodes, the proton conductor comprising a carbon cluster derivative that comprises a plurality of functional groups so as to be capable of transferring a plurality of protons between each of the functional groups of the carbon cluster derivative wherein the proton conductor further comprises a dry gel material.

16. An electrochemical device according to claim 15, wherein the carbon cluster derivative comprises a cluster that substantially contains a plurality of carbon atoms, the cluster comprises a length along a minor axis of 100 nm or less and wherein the cluster comprises two or more functional groups.

17. An electrochemical device according to claim 15, wherein the carbon cluster derivative substantially comprises CNₓ nanotubes where x is about 2 to about 7 atomic %.

18. An electrochemical device according to claim 15, wherein the functional groups are expressed by —XH where X represents an arbitrary atom or atomic group that has a bivalent bound and where H represents a hydrogen atom.

19. An electrochemical device according to claim 15, wherein the functional groups are expressed by —OH or —YOH where Y represents an arbitrary atom or atomic group that has a bivalent bound, where O represents oxygen atom, and where H represents a hydrogen atom.

20. An electrochemical device according to claim 15, wherein the functional groups selected from the group consisting of hydroxyl, carboxyl, carbonyl, —SO₃H, —OSO₃H, —OP(OH)₃ and their mixtures.

21. An electrochemical device according to claim 15, wherein the carbon cluster derivative further comprises a plurality of electron attractive groups in additional to the functional groups.

22. An electrochemical device according to claim 15, wherein the electron attractive groups are selected from the group consisting of nitro groups, nitrile groups, alkyl halide groups, fluorine atoms or chlorine atoms.

23. An electrochemical device according to claim 15, wherein the dry gel material has no electronic conductivity.

24. An electrochemical device according to claim 15, wherein the dry gel material comprises about 20 wt % or more.

25. An electrochemical device according to claim 15, wherein the dry gel material is an aggregate containing atoms chosen from the group comprising hydrogen, oxygen, phosphorous, silicon, germanium, aluminum, cerium, zirconium and their mixtures.

26. An electrochemical device according to claim 25, wherein the atomic ratio of phosphorus to silicon is about 1.

27. An electrochemical device according to claim 15, wherein the proton conductor comprises a thin film that has a dry film thickness of 300 microns or less.

28. An electrochemical device according to claim 15, wherein the electrochemical device compromises a fuel cell.

29. An electrochemical device according to claim 28, wherein the electrochemical device comprises a fuel cell operating on air and a fuel chosen from the group compromising hydrogen, methanol, ethanol, gasoline, diesel fuel, carbon monoxide, ammonia and their mixtures.

30. An electrochemical device according to claim 15, wherein each of the first and second electrodes comprise a gas electrode.

31. An electrochemical device according to claim 15, wherein one of the first and second electrodes comprises a gas electrode.

32. An electrochemical device according to claim 15, wherein each of the first and second electrodes comprise an active electrode.

33. An electrochemical device according to claim 15, wherein at least one of the first and second electrodes comprises an active electrode.
